(19) United States
(12) Patent Application Publication
(10) Pub. No.: US 2007/0064682 A1
(43) Pub. Date: Mar. 22, 2007

(54) Methods and computer program products for managing a plurality of voice-over internet protocol phone lines in customer premises equipment

(76) Inventors: Jennifer Adams, Atlanta, GA (US); Brett Johnson, Acworth, GA (US); Greg Newton, Dunwoody, GA (US); Alan Christopher Stone, Atlanta, GA (US); Tuck Seng Tan, Atlanta, GA (US); Phillip Anthony Weeks, Atlanta, GA (US)

Correspondence Address: MYERS BIGEL SIBLEY & SAJOVEC, P.A., P.O. BOX 37428, RALEIGH, NC, 27627, US

(21) Appl. No.: 11/311,765

(22) Filed: Dec. 19, 2005

Related U.S. Application Data
(60) Provisional application No. 60/718,251, filed on Sep. 16, 2005.

(51) Int. Cl. H04L 12/66

(52) U.S. Cl. 370/352

(57) ABSTRACT

A method of managing a plurality of Voice-Over Internet Protocol (VoIP) phone lines assigned to a VoIP Customer Premises Equipment (CPE). A VoIP call window is displayed on a display device of the VoIP CPE. A different one of a plurality of sub-windows are assigned to each of the different VoIP phone lines. The sub-windows are displayed so that they can be viewed at the same time within the VoIP call window. An indicia is displayed within each of the sub-windows that identifies with which of the VoIP phone lines each sub-window is assigned.

### CROSS REFERENCE RELATED APPLICATIONS

This Application is related to and claims the benefit of priority to U.S. Provisional Patent Application No. 60/718,251, filed Sep. 16, 2005, entitled VOIP SOFTPHONE, the disclosure of which is hereby incorporated herein by reference.

### FIELD OF THE INVENTION

The present invention generally relates to the field of telephony, and more particularly to methods and computer program products for managing voice-over Internet protocol calls on a plurality of lines assigned to a customer premises equipment.

### BACKGROUND

The Internet has become a mainstream network for communicating not just data, such as email and pictures, but also for providing real-time bi-directional voice communications. Voice Over Internet Protocol (VoIP) is an industry standard that has evolved to enable users to place phone calls at least in part through the Internet, instead of entirely through the Public Switched Telephone Network (PSTN). A conventional phone, personal computer, or other Consumer Premises Equipment (CPE) may be used as a VoIP terminal to provide VoIP communications. For example, a conventional (analog) phone may be connected to the Internet using an interface device that converts analog voice signals to digital signals that can be communicated through the Internet. A personal computer may also be configured through a software application, sometimes referred to as a soft-phone application, to make and receive VoIP calls through the Internet. A user may use a VoIP phone to generate a phone call that is communicated through the Internet to a VoIP provider, which converts the call back to an analog signal and places the call through the PSTN that is local to the called phone.

VoIP phones may provide functionality that is not provided by PSTN type phones. For example, a single VoIP phone may be assigned a plurality of different VoIP telephone numbers and it may enable a user to make multi-party conference calls from those VoIP telephone numbers. The increasing functionality offered by VoIP phones continues to drive the need for more advanced user interfaces on those phones.

### SUMMARY

Embodiments according to the invention can provide methods and computer program products for managing a plurality of VoIP phone lines assigned to a VoIP CPE. According to some embodiments, a computer program product includes a computer readable medium that includes computer readable program code. Some computer readable program code is configured to display a VoIP call window on a display device of the VoIP CPE. Other computer readable program code is configured to assign a different one of a plurality of sub-windows to each of the different VoIP phone lines. Further computer readable program code is configured to display the sub-windows so that they can be viewed at the same time within the VoIP call window. Further computer readable program code is configured to display indicia within each of the sub-windows that identifies with which of the VoIP phone lines each sub-window is assigned.

Accordingly, for a VoIP CPE that has been assigned a plurality of VoIP phone lines, a sub-window can be displayed for each VoIP phone line so that a user may observe information, such as the line status, associated with each VoIP phone line. Moreover, further computer readable program code and methods for making, receiving, transferring, and performing other actions for VoIP calls on the VoIP phone lines can be managed via the assigned sub-windows, which will be explained in detail below with regard to various embodiments of the present invention.

### BRIEF DESCRIPTION OF THE FIGURES

FIG. 1 is a block diagram of a VoIP communication system including VoIP CPEs that communicate with PSTN CPE and other VoIP CPEs via a VoIP service provider according to various embodiments of the present invention.

FIG. 2 is a block diagram of one of the VoIP CPE shown in FIG. 1 according to some embodiments of the present invention.

FIGS. 3-28 are schematic illustrations of methods and associated computer program operations for managing a plurality of VoIP phone lines assigned to one of the VoIP CPEs of FIG. 1 according to various embodiments of the present invention.

FIG. 29 is a flowchart that illustrates operations for managing a plurality of VoIP phone lines assigned to one of the VoIP CPEs of FIG. 1 according to various embodiments of the present invention.

### DESCRIPTION OF THE EMBODIMENTS ACCORDING TO THE INVENTION

The present invention now will be described more fully hereinafter with reference to the accompanying figures, in which embodiments of the invention are shown. This invention may, however, be embodied in many alternate forms and should not be construed as limited to the embodiments set forth herein. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the term “and/or” includes any and all combinations of one or more of the associated listed items.

It will be understood that, when an element is referred to as being “coupled” to another element, it can be directly coupled to the other element or intervening elements may be present. In contrast, when an element is referred to as being “directly coupled” to another element, there are no intervening elements present. Like numbers refer to like elements throughout.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense expressly so defined herein.

The present invention may be embodied as methods, apparatus, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, or transport the program for use by or in connection with the instruction execution system, apparatus, or device.

The computer-usable or computer-readable medium may be, for example but not limited to, an electronic, magnetic, optical, electromagnetic, or semiconductor system, apparatus, device, or other tangible medium. More specific examples (a nonexhaustive list) of the computer-readable medium would include the following: a portable computer diskette, a random access memory (RAM), a read-only memory (ROM), an erasable programmable read-only memory (EPROM or Flash memory), and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described below with reference to block diagrams and/or operational illustrations of methods, apparatus, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

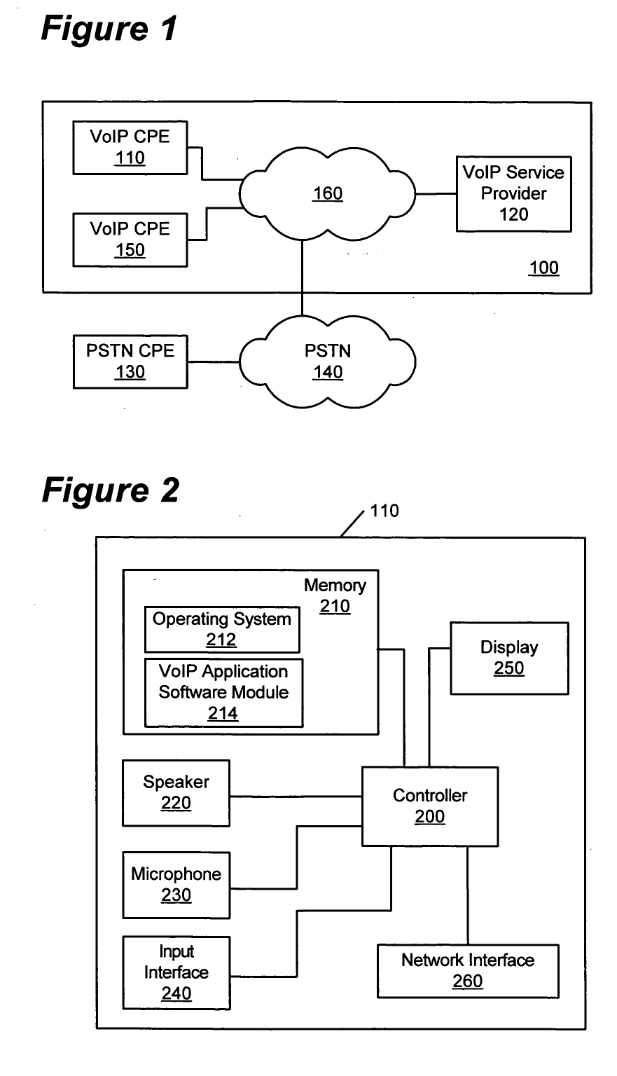

FIG. 1 is a block diagram of a VoIP communication system 100 that includes a VoIP CPE 110 serviced by a VoIP service provider 120 according to various embodiments of the present invention. The VoIP CPE 110 can communicate with PSTN CPE 130 (e.g., a conventional analog phone) via a Public Switched Telephone Network (PSTN) 140 and/or can communicate with another VoIP CPE 150. The VoIP communication system 110 enables phone calls to be initiated and/or received by the VoIP CPEs 110,150 and/or the PSTN CPE 130 via the Internet 160, and such phone calls are sometimes referred to as VoIP phone calls. It will be understood that the Internet 160 referred to herein may be any packet switched data network.

FIG. 2 is a block diagram of the VoIP CPE 110 according to some embodiments of the present invention. The VoIP CPE 110 may be, for example, a personal computer (e.g., desktop, laptop, palmtop computer) that includes a controller 200, memory 210, speaker 220, microphone 230, user input interface 240 (e.g., touch screen overlay on display 250, keyboard, and/or mouse device), display 250, and network interface 260. Accordingly, a user may select a portion of a window, button, or other portion of a displayed image by, for example, touching a corresponding portion of the display 250, moving a cursor into a corresponding area of the image, and/or clicking a mouse button or actuating another defined device while the cursor at least partially overlaps a corresponding area of the image.

The memory 210 is representative of the overall hierarchy of memory devices containing an operating system 212 and VoIP application software module 214. The VoIP module 214 contains program code that when executed by the controller 200 provides the functionality of the VoIP CPE 110 according to at least some of the embodiments described herein. The VoIP module 214 configures the controller 200 to make and/or receive VoIP phone calls through the network interface 260.

The network interface 260 is configured to communicatively interface the VoIP CPE 110 to the Internet 160, and may include, for example, a broadband data modem, such as a cable Internet modem, a Digital Subscriber Line (DSL) Internet modem, and/or a wireless network Internet modem that utilizes a wireless protocol such as, for example, a cellular protocol (e.g., General Packet Radio System (GPRS), Enhanced Data Rates for Global Evolution (EDGE), Global System for Mobile Communications (GSM), code division multiple access (CDMA), wideband-CDMA, CDMA2000, and/or Universal Mobile Telecommunications System (UMTS)), a wireless local area network protocol (e.g., IEEE 802.11), a Bluetooth protocol, and/or another wireless communication protocol.

A subscriber may setup VoIP services by registering with the VoIP service provider 120 and being assigned one or more VoIP phone numbers (lines) which may be programmed into the VoIP CPE 110. The VoIP service provider 120 can then route phone calls from/to VoIP phone numbers (VoIP phone lines) associated with the VoIP CPE 110 based on a called phone number (e.g., the phone number to which the phone call is directed). For example, the VoIP service provider 120 may route and establish a phone call from the VoIP CPE 110 through local access Internet providers (not shown) and the Internet 160, and through a trunk gateway (also not shown) and the PSTN 140 to the PSTN CPE 130. The PSTN CPE 130 may be a conventional plain old telephone system (POTS) telephone. The VoIP service provider may also route and establish a phone call from the VoIP CPE 110 through the Internet 160 to the other VoIP CPE 150.

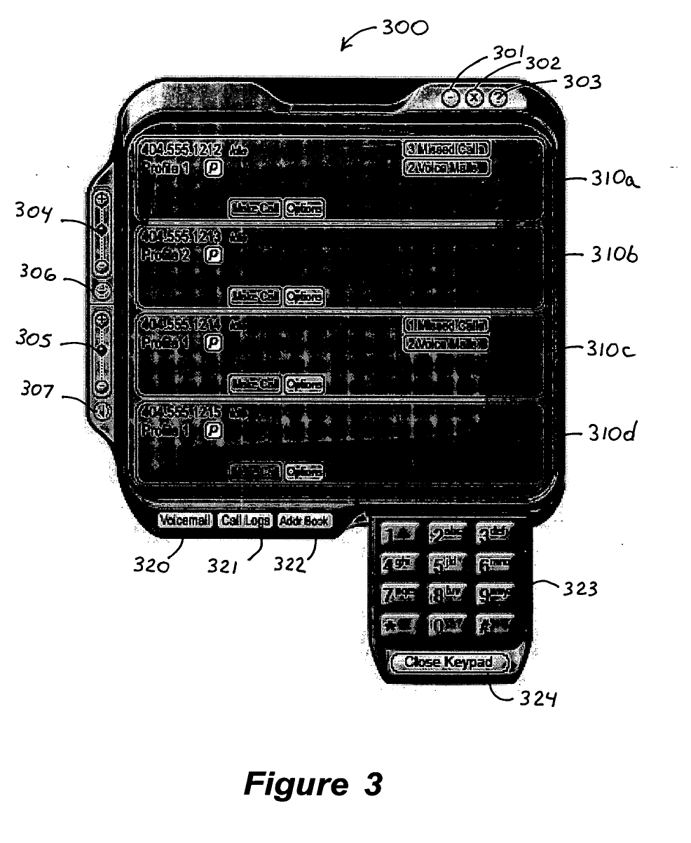

FIGS. 3-28 are schematic illustrations of computer program products, including the VoIP module 214, and associated methods for managing a plurality of VoIP phone lines assigned to the VoIP CPE 110 of FIG. 1.

Referring to FIGS. 2 and 3, the display 250 can be configured, via the VoIP module 214 and controller 200, to display a VoIP call window 300. The VoIP call window 300 provides various buttons, sliders, and keys that are selectable/movable by a user using, for example, a mouse, touch sensitive portion of the display 250, and/or other element of the input interface 240, to cause various functions to be carried out by the controller 200. Buttons 301, 302, and 303 can be selected by a user to respectively minimized the window 300 (reduce window 300 to a defined symbol on a menu-bar provided by the operation system 212), close the window 300, and open a help window. Slider 304 can be moved to vary the sensitivity of the microphone 230, and button 306 can be selected to alternately turn on/off the microphone 230. Slider 305 can be moved to vary the volume through the speaker 220, and button 307 can be selected to alternately turn on/off the speaker 220.

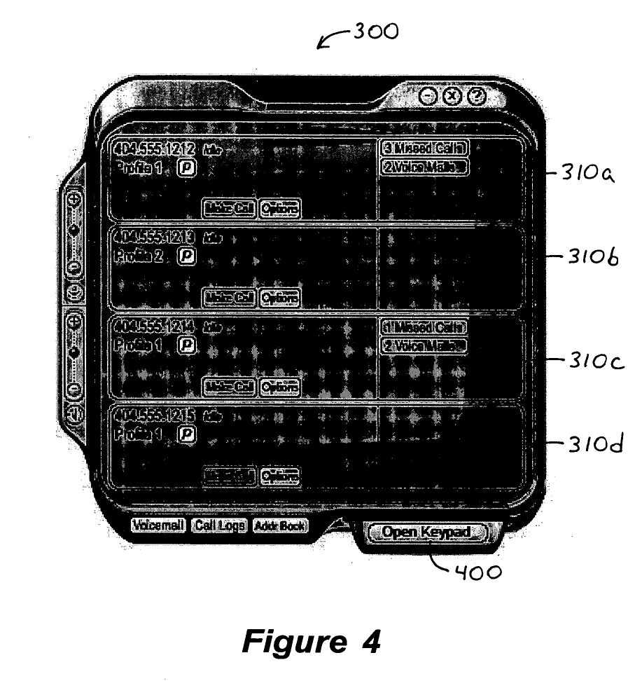

A voicemail button 320 can be selected to display a voice mail window in which information associated with messages in voice mailboxes assigned to each of the VoIP phone lines can be simultaneously shown. A call logs button 321 can be selected to display a call log window in which information on incoming and/or outgoing phone calls associated with each the VoIP phone lines can be simultaneously shown. An address book button 322 can be selected to display a window in which address information from an address book (database) in the VoIP CPE 110 can be displayed. The VoIP call window 300 can also include a keypad 323 (with a plurality of numeric keys (e.g., 0-9, *, #) that may be arranged according to a conventional phone keypad. The keypad 323 may be opened by selecting an “open keypad” button 400 (FIG. 4) and/or may be opened in response to a user initiating a phone call sequence, and may be closed in response to a user selecting a close button 324.

The VoIP call window 300 simultaneously displays a plurality of graphical VoIP phone line sub-windows 310a-d, each of which can be associated with a different VoIP phone line assigned to the VoIP CPE 110. As shown in FIG. 3, the VoIP CPE 110 has been assigned four VoIP phone line numbers 404.555.1212, 404.555.1213, 404.555.1214, and 404.555.1215. Each of the four VoIP phone line numbers is displayed in a different one of the sub-windows 310a-d. Although four different lines and associated sub-windows 310a-d have been illustrated in FIG. 3 for purposes of explanation, it is to be understood that any number of lines and associated sub-windows may be simultaneously displayed in the VoIP call window 300 subject to the size and resolution of the display 250. Moreover, some of the sub-windows may extend beyond the viewable area of the display 250, in which case a scroll-bar may be provided to allow a user to scroll the sub-windows across the viewable area of the display 250.

Each of the sub-widows 310a-d also displays the state of the associated VoIP phone line. The states displayed for each VoIP phone line may include, but are not limited to, “idle”, “incoming call, “call in progress”, “call on hold”, “3-way call”, “registering”, and “unregistered”. For example, sub-window 310a indicates that line 404.555.1212 has an “idle” state, corresponding to that line being registered with the VoIP service provider 120 and it not being presently used for an incoming call or an in-progress call. When an “incoming call” state is displayed, that line is presently being called by another CPE (e.g., by VoIP CPE 110 or PSTN CPE 130). When a “call in progress” state is displayed, that line is presently being used to call another CPE and/or a call is presently established with another CPE. When a “call on hold” state is displayed, that line has been put on hold. When a “3-way call” state is displayed, that line can be presently connected to two or more other CPEs in a multi-party conference call. Although a 3-way call is described in some embodiments herein, it is to be understood that three or more CPEs may be simultaneously connected in a multi-party conference call. When a “registering” state is displayed, that line is presently being registered with the VoIP service provider 120, and display of an “unregistering” state indicates that that line has not being properly registered with the VoIP service provider 120 (e.g., the provider 120 has not authorized use of that line). In FIG. 3, each of the phone lines shown in sub-windows 310a-d has an “idle” state.

Each of the sub-widows 310a-d also displays action and line information buttons that cause various actions and information associated with a line to be displayed. The buttons displayed in each sub-window 310a-d may include, but are not limited to, “make call” button, “options” button, “missed call” button, and “voice mail” button. The “make call” button can be selected to initiate a call sequence on the VoIP phone line associated with that sub-window, and which may trigger operations to display the keypad 323, sense a called number selected by a user (e.g., via the keypad 323, an address book, and/or keyboard element of interface 240), and generate a call to the VoIP service provider 120.

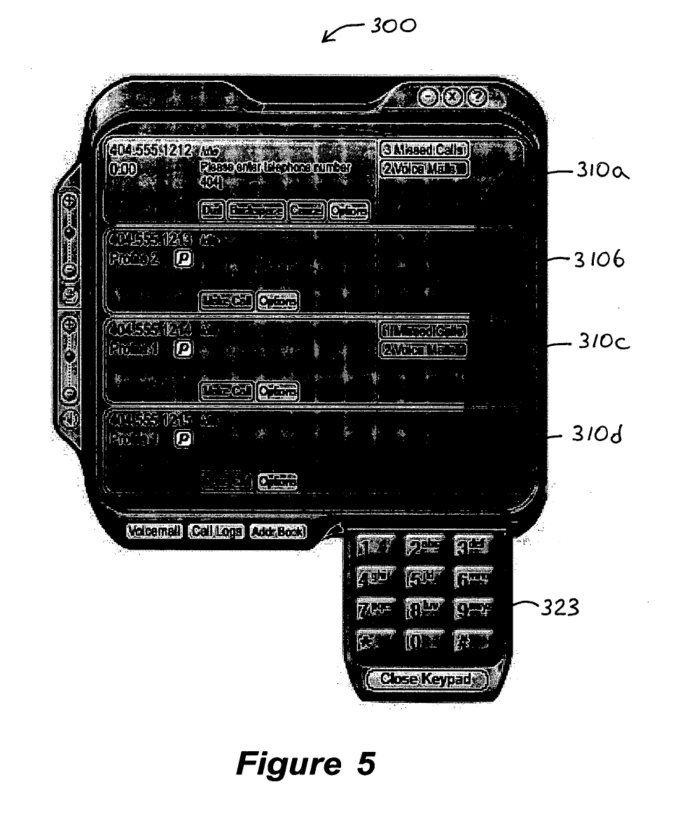

By way of example, a call can be initiated on phone line 404.555.1212 by selecting the “make call” button in sub-window 310a of FIG. 3, which causes that sub-window to change to the configuration shown in FIG. 5. Referring to FIG. 5, as a phone number is entered by a user (e.g., via mouse/touch screen selections on displayed keypad 323 and/or via typing on interface 240) it is displayed in sub-window 310a (i.e., “404”). The keypad may be automatically opened, without further input from the user, in response to the user selection of the “make call” menu item. The “make call” button is replaced by a “dial” button, “backspace” button, and “cancel” button. Selection of the “dial” button causes a VoIP call to be initiated via the VoIP service provider 120 to the entered phone number. Momentary selection of the “backspace” button deletes the last entered phone number digit while selection of the “backspace” button for a threshold time (e.g., 2 seconds) causes all entered digits to be erased, and selection of the “cancel” button returns the line assigned to sub-window 310a to the idle state shown in FIG. 1. A call timer is also displayed in the sub-window 310a showing the time duration of a call once placed to the service provider 120.

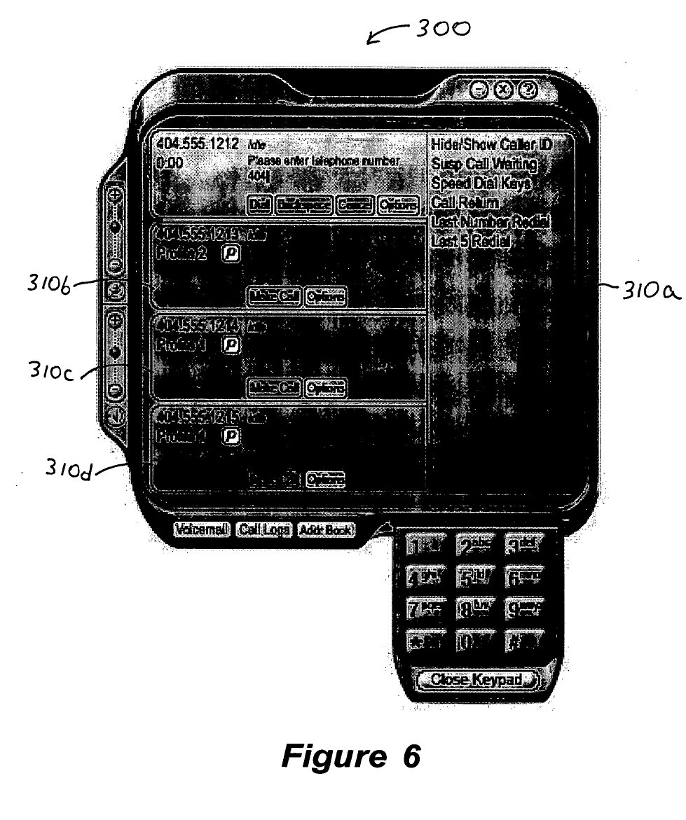

Referring to FIG. 6, selection of the “options” button causes available options for placing the call to be displayed in an expanded sub-window 310a. The available call options may be displayed as a selectable menu item list, and selection among the list may cause actions that can include: selectively hiding/showing the phone number from which the call is originating (e.g., selectively hide/show the originating line number 404.555.1212 of the call to a called CPE); suspending call waiting on that line; displaying speed dial keys to enable a user to dial a defined number sequence by selecting an associated one of the displayed key; returning a call to a CPE that previously called; redialing a last called phone number; and displaying a list of previously called phone numbers from which a user may select one of the displayed phone numbers to be presently called. The menu item list may also enable a user to add a selected number to a blocking list of phone numbers (e.g., complete phone numbers or portions thereof, such as area codes) that are blocked from being called using that particular phone line and/or all of the phone lines assigned to the VoIP CPE 110.

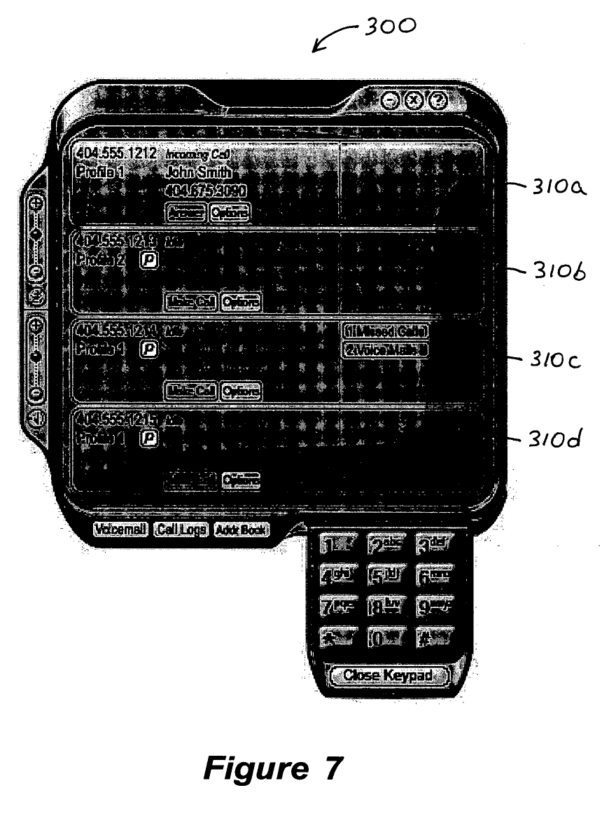

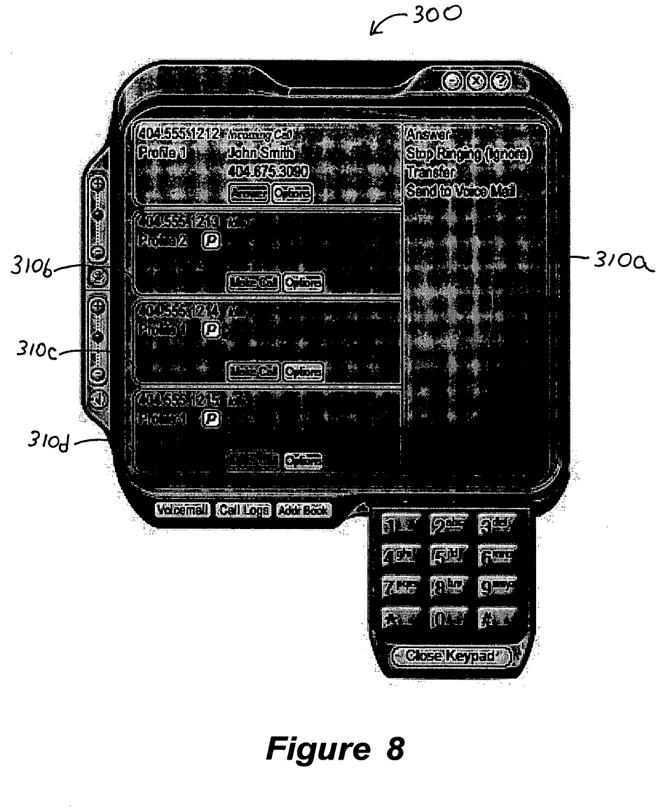

FIG. 7 illustrates a state in which an call is incoming is being received on phone line 404.555.1212 assigned to sub-window 310a. In response to the incoming call, the “make call” button changes to an “answer” button, the status of that line in sub-window 310a changes from “idle” to “incoming call”, and the name and associated telephone number of the incoming call are displayed when that caller-ID information is received with the incoming call. Selection of the “options” button causes the available answer options to be displayed as a selectable menu time list in an expanded sub-window 310a, such as that shown in FIG. 8, and selection among the list may cause actions that can include: answering the call; stopping ringing (e.g., cease the generation of an audible and/or visual announcement from CPE 110 of the incoming call); transferring the incoming call to another one of the phone lines and/or routing it to another phone number; and sending the incoming call to be answered by a voice mailbox application within the VoIP application software module 214 or within the VoIP service provider 120.

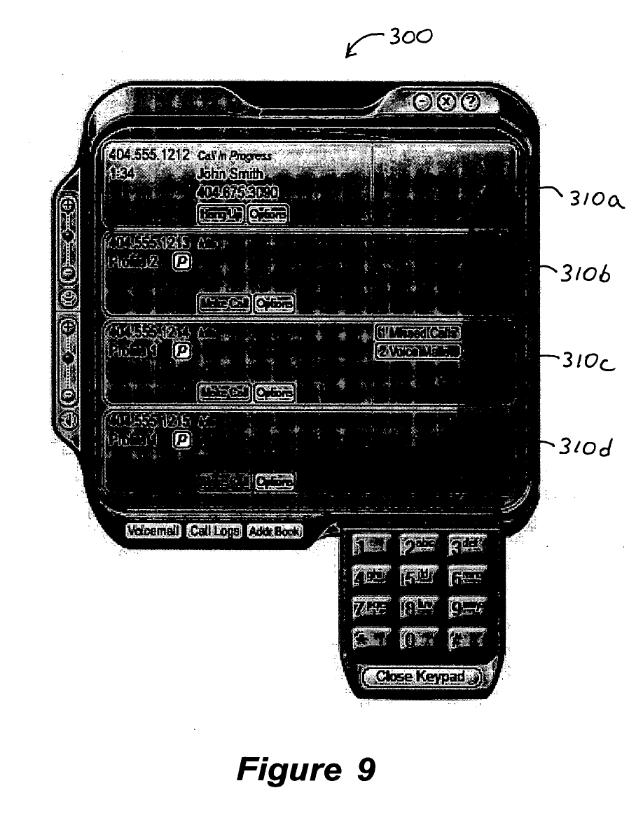

Selection of the “answer” button/list item causes the incoming call to be answered, incoming sound (e.g., voice) to be routed to the speaker 220 (unless if muted by button 307), and sound sensed by microphone 230 to be converted and sent as outgoing data to the calling CPE (unless if muted by button 306). FIG. 9 illustrates the VoIP call window 300 with a “call in progress” state displayed in sub-window 310a. The “answer” button shown in FIG. 8 has been changed in FIG. 9 into a “hang up” button which may be selected by a user to terminate the call that is presently in progress and to return the line state to “idle” (see FIG. 1).

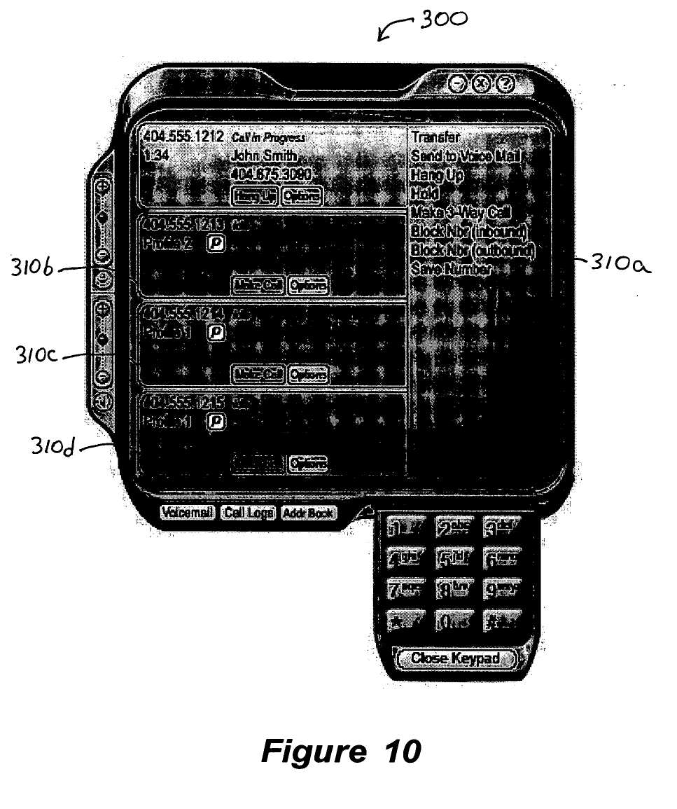

Selection of the “options” button causes available options for the call in progress to be displayed in an expanded sub-window 310a. The available call options may be displayed as a selectable menu item list, such as that shown in FIG. 10, and selection among the list may cause actions that can include: transferring the call in progress to another phone number and ending calling on that line (e.g., transfer call to phone no. 404.555.1213 and return line 404.555.1212 to idle state); sending the call in progress to an associated voice mailbox; hanging up (terminating) the call in progress; placing the call in progress on-hold; joining the call in progress to another call to form a multiple party conference call (e.g., “Make 3 way call” button); adding the phone number associated with a received call to the blocking list so that calls from that phone number are subsequently blocked from being received (e.g., “Block Nbr (inbound)” button); adding the phone number associated with a CPE 110 original call to the blocking list so that calls to that phone number are subsequently blocked from being called (e.g., “Block Nbr (outbound)” button); and adding the call/received phone number to the address book (i.e., phone number and contact information database).

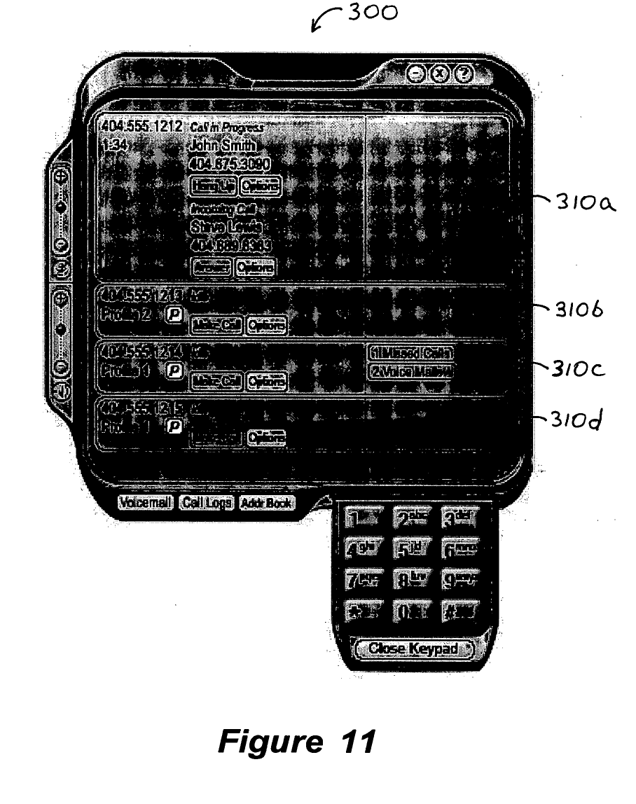

FIG. 11 illustrates how sub-window 310a can be changed in response to receipt of an incoming call on line 404.555.1212 while a call is in progress on that line. As shown, the sub-window 310a is sufficiently expanded to enable display of an “incoming call” indication along with caller ID information when received with the incoming call. An “answer” button and “option” button is also displayed associated with the incoming call. Accordingly, as shown in FIG. 11, sub-window 310a can display the status and caller ID information for both the call in progress and the incoming call.

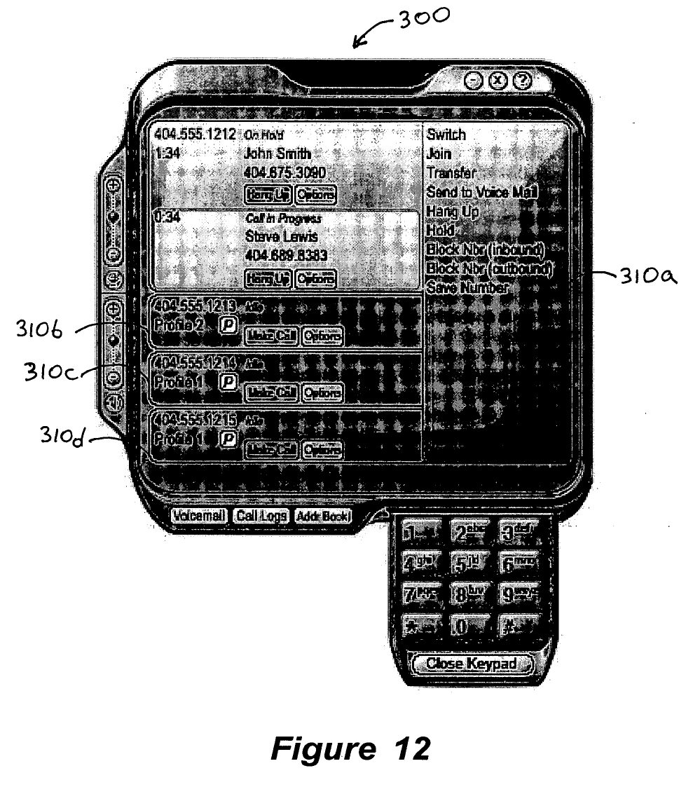

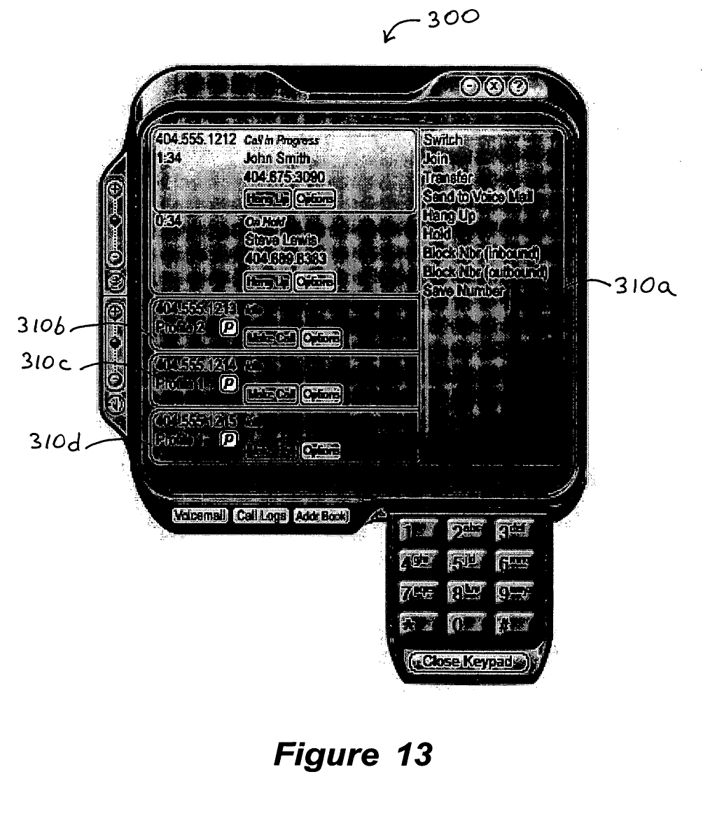

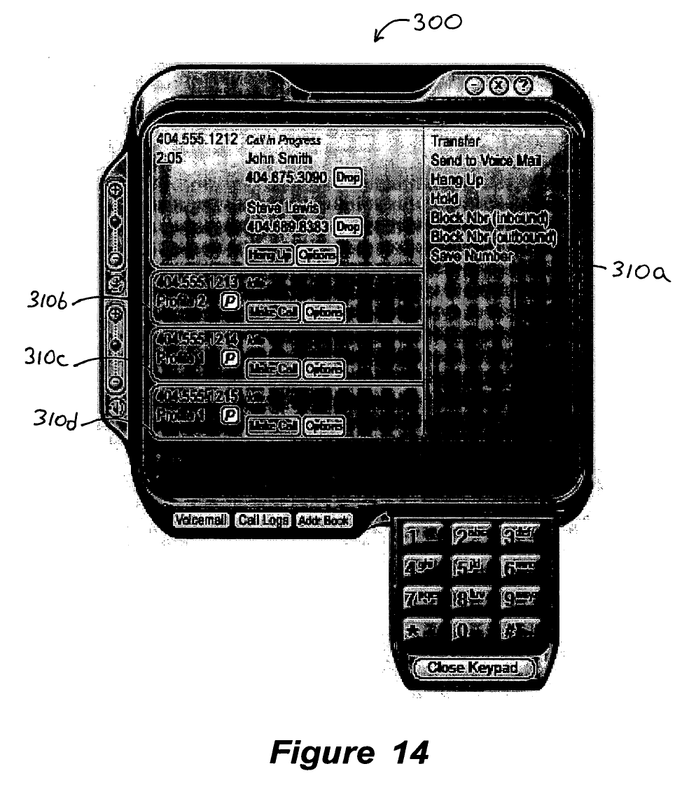

FIG. 12 illustrates how the sub-window 310a can be changed in response to a user selection of the “answer” button for the incoming call. The original call in progress is automatically placed on hold, without necessitating further input from the user, with its displayed status changed to “on hold”, and the incoming call is answered with its displayed status changed to “call in progress”. Selection of the options button for the call in progress causes available options for the call in progress to be displayed. The available call options may be displayed as a selectable menu item list, such as that shown in FIG. 12, and may be similar to that explained with explained with regard to FIG. 10, except for the provision of a “switch” menu item and a “join” menu item. Selection of the “switch” menu item swaps the on hold call and the call in progress, so that the on hold call becomes the active call in progress and the previously active call in progress is placed on hold, such as shown in FIG. 13. Selection of the “join” menu item combines the separate call on-hold and call in progress into a single multi-party conference call on line 404.555.1212, such as shown in FIG. 14. As shown in FIG. 14, when two or more calls are joined into a multi-party conference call a “drop” button is displayed next to each party in the call. Thus, for example, selection of the “drop” button adjacent to the phone number of one of the parties (e.g., no. 404.675.3090) causes that party to be terminated from the call.

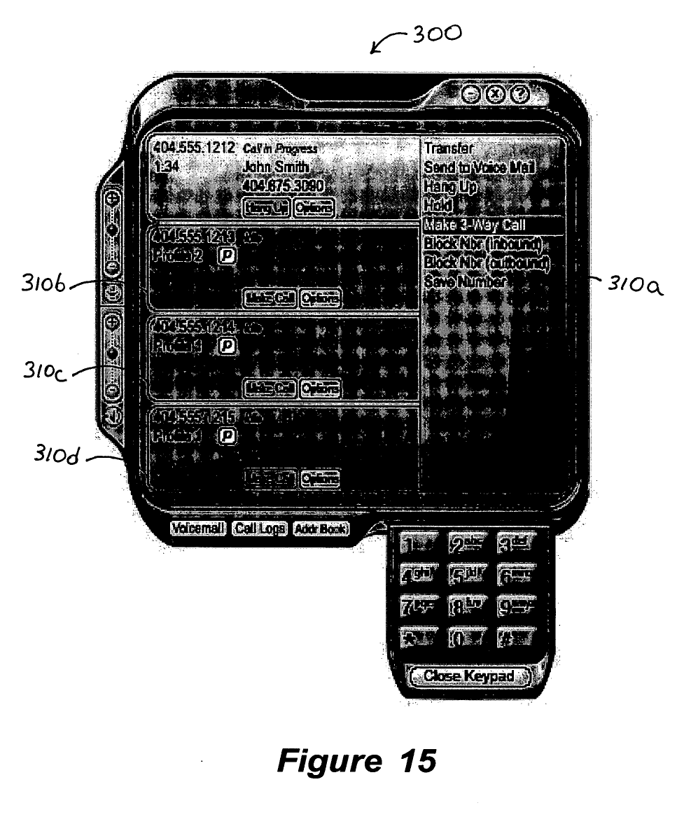

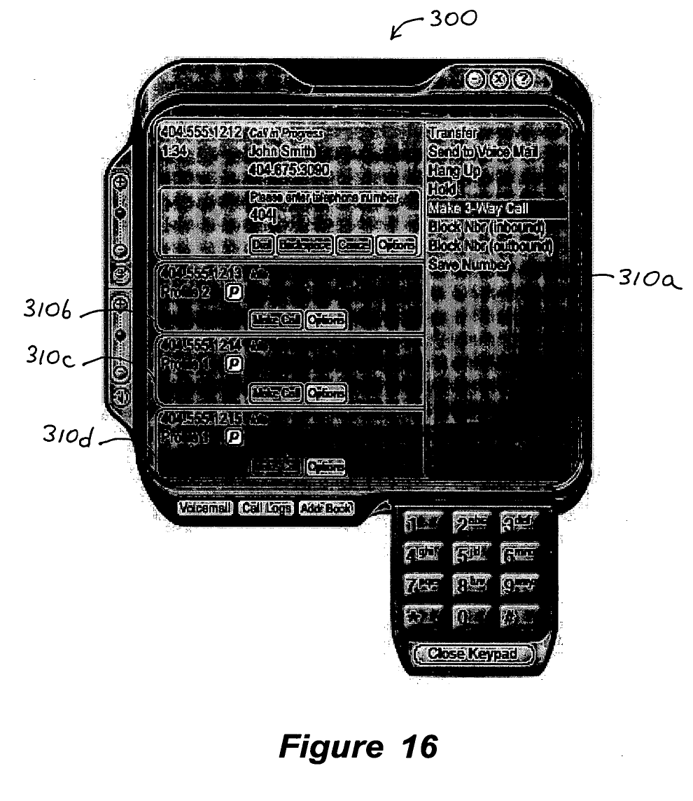

FIG. 15 illustrates that the “Make 3-Way Call” menu item has been highlighted for selection by a user (i.e., highlighted in response to a movable cursor being placed thereon). FIG. 16 illustrates how the sub-window 310a can be changed in response to a user selection of the “Make 3-Way Call” menu item shown in FIG. 15 to initiate a multi-party call. In response to that selection, sub-window 310a is sufficiently expanded to enable display of a prompt for the user to enter the telephone number that is to be called to form a multi-party call. The phone number may be displayed as it is typed on the displayed keypad 323 and/or on the keyboard or other interface 240. The keypad may be automatically opened, without further input from the user, in response to the user selection of the “Make 3-Way Call” menu item. The displayed “Dial” button, “Backspace” button, and “Cancel” button may operate as was described with regard to the same labeled buttons shown in FIG. 5.

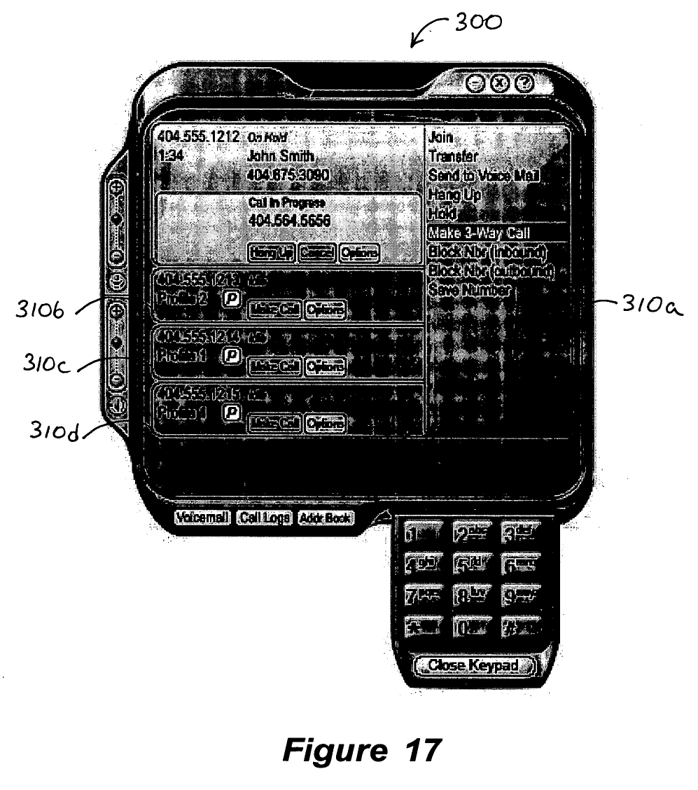

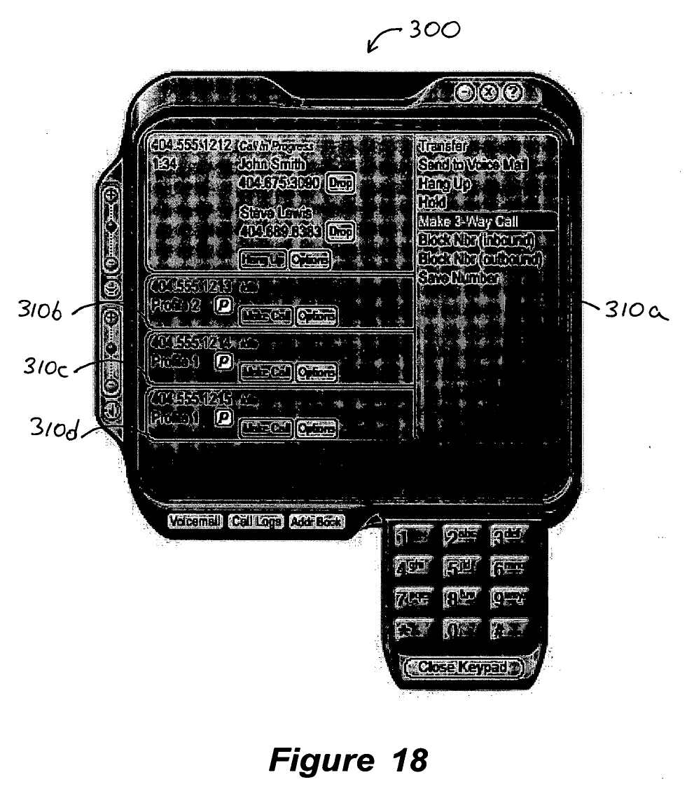

FIG. 17 illustrates the second call on line 404.555.1212 with a “Call In Progress” status while the first call has an “On Hold” status. The user may then select the “Join” menu item to combine the first call “On Hold” with the second call that is “Call In Progress” to generate a three-way call on line 404.555.1212 with phone numbers 404.675.3090 and 404.564.5656. FIG. 18 illustrates the three-way call after combining the first and second call. A “Drop” button is displayed adjacent to each of the in-progress calls so that the corresponding call can be dropped from the three-way call by selection of the adjacent “Drop” button.

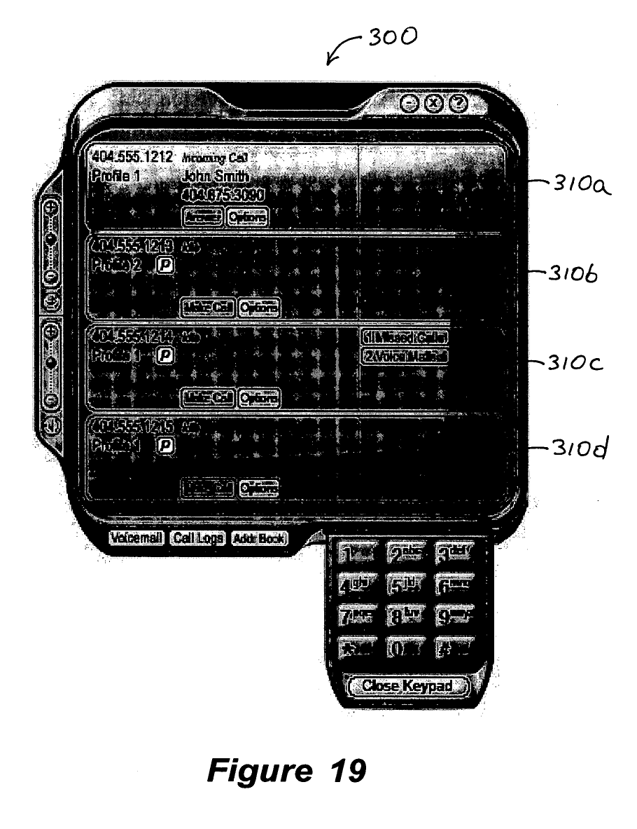

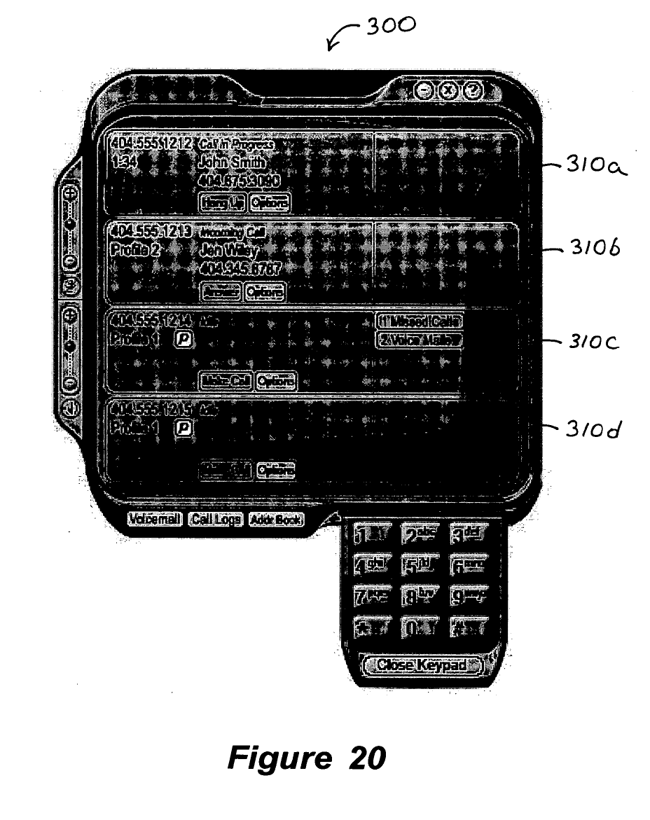

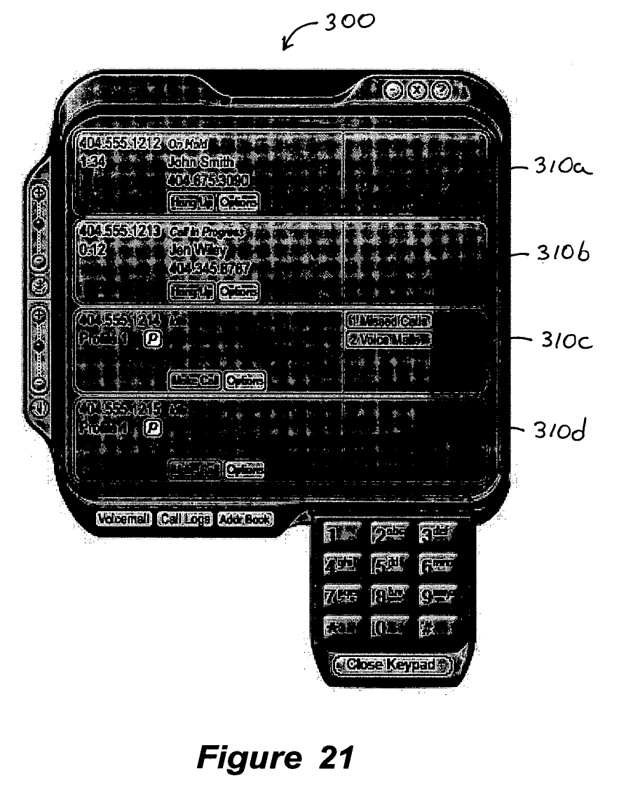

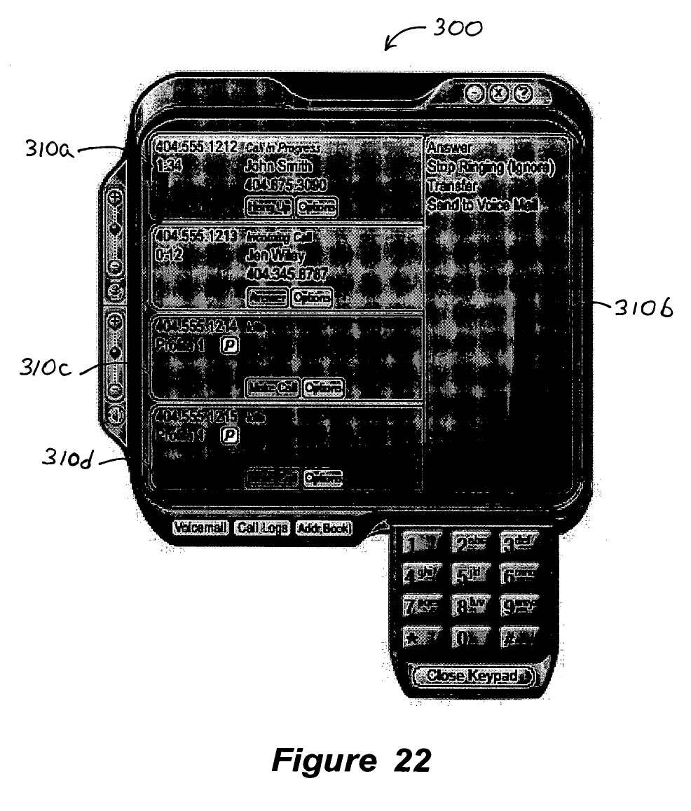

FIG. 19 illustrates the sub-window 310a with a call status of “Incoming Call” to indicate that a call to line 404.555.1212 is presently being received. FIG. 20 illustrates a “Call In Progress” status in sub-window 310a and an “Incoming Call” status in sub-window 310b to indicate that a call to line 404.555.1213 is presently being received. Selection of the “Options” button in sub-window 310b causes the available operations that may be performed on the incoming call to be displayed. Referring to FIG. 22, the available selectable operations that may be displayed can include: “Answer” which causes the incoming call to be answered; “Stop Ringing (Ignore)” which terminates generation of the audible and/or visual indication to the user of the incoming call; “Transfer” which causes the incoming call to be transferred to another line assigned to the VoIP CPE 110 and/or to another phone number entered by the user; and “Send to Voice Mail” which causes the incoming call to be transferred to an associated voice mailbox. In response to selection of the “Answer” button in sub-window 310b, the call to line 404.555.1213 from phone number 404.345.8787 is answered and the call on line 404.555.1212 with phone number 404.675.3090 is automatically placed on hold without further action by the user. Accordingly, as shown in FIG. 21, the call status in sub-window 310a is changed to “On Hold” and the call status in sub-window 310a is changed to “Call In Progress”.

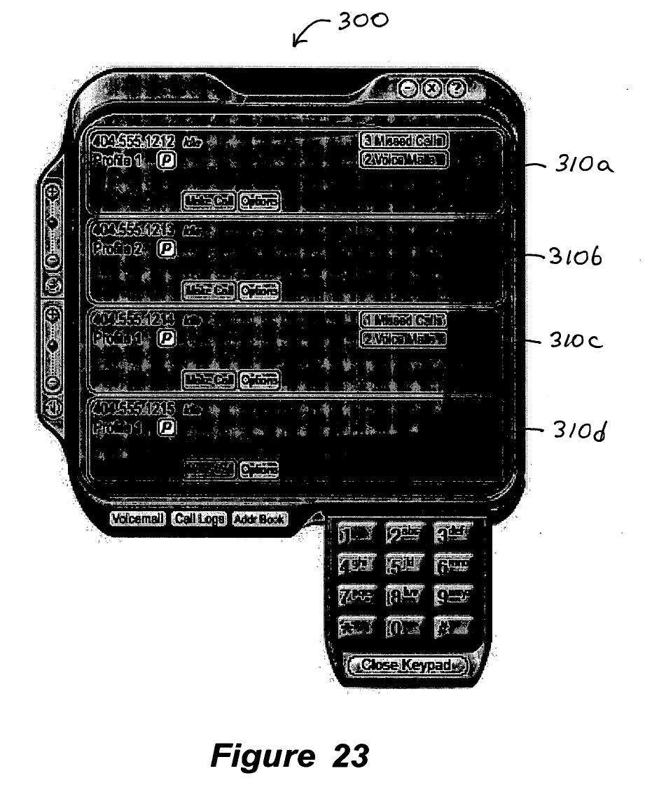

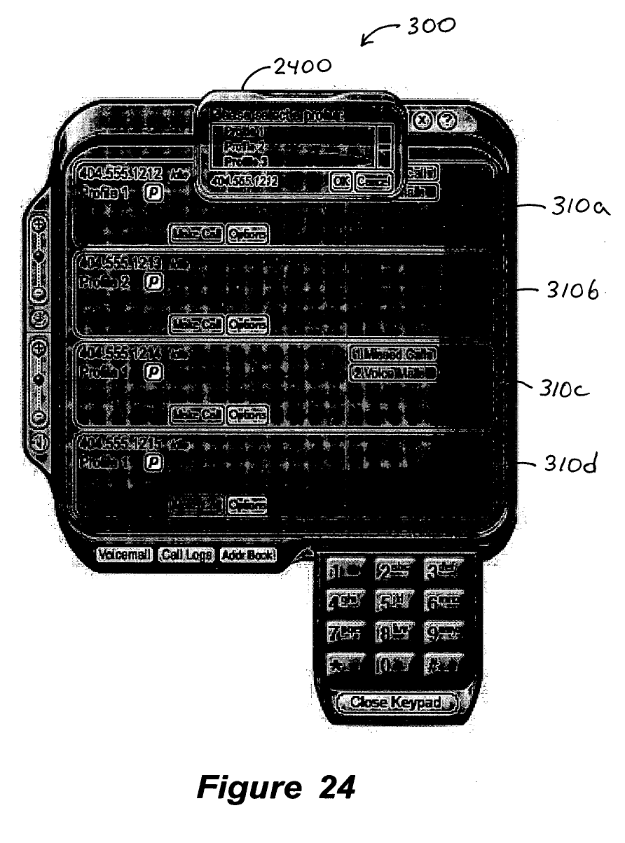

Referring now to FIG. 23, each of the illustrated four lines in sub-windows 310a-d has a defined profile, such as “Profile 1” in sub-windows 310a,c,d and “Profile 2” in sub-window 310b. A profile “P” button is displayed adjacent to the indicated profiles in each sub-window and can be selected by a user to change the profile associated with a particular one of the lines. For example, selection of the profile “P” button in sub-window 310a causes a list of predefined profiles to be displayed, three of which are illustrated in FIG. 24 in pop-up window 2400, and a user may select among the displayed profiles to assign a new profile to the first line (404.555.1212). Each of the defined profiles may be predefined by a user and may define a group of phone numbers that are to be blocked from being received, a group of phone numbers that block from being called, one or more phone numbers to which an incoming call is to be forwarded, and/or an available status (e.g., do not disturb status). Accordingly, a user may associated a profile with each of the phone lines by selecting the profile “P” button in associated sub-windows and selecting the profile that is to be assigned to that sub-window among the profiles in the pop-up window 2400. A user may thereby assign a profile to the phone line of sub-window 310a that has a do-not-disturb status so that incoming calls thereto are automatically routed to another phone number and/or voice mail defined by that profile, and can assign a different profile to the phone line of sub-window 310b that blocks incoming calls from a different group of phone numbers than defined by the profile assigned to sub-window 310a but which allows calls to be received from other phone numbers. When the do-not-disturb status in a line profile is set, the VoIP CPE 110 may not generate an audible and/or visual announcement for an incoming call to the user. Because the profile associated with each line is displayed in the respective sub-windows 310a-d, a user can visually confirm which profiles have been assigned to what phone lines.

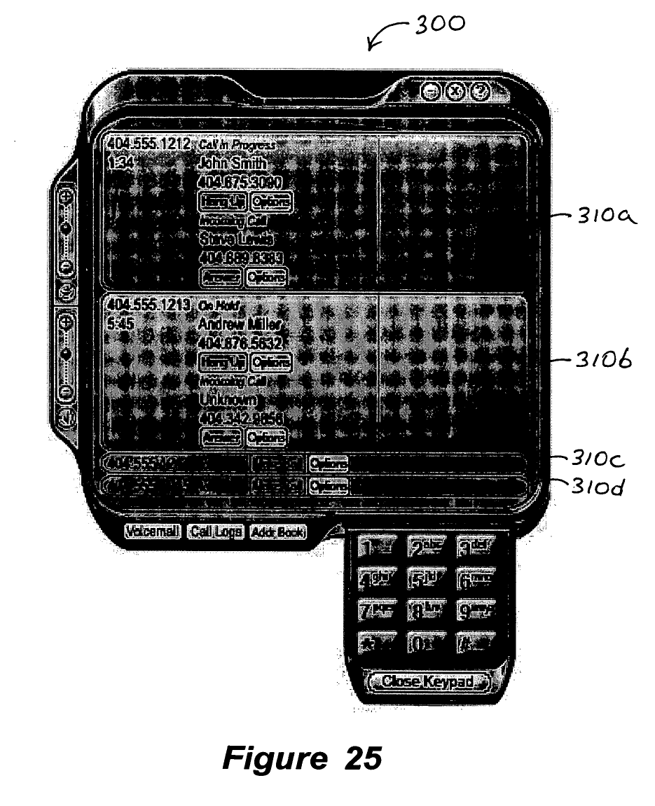

With reference to FIG. 25, call waiting on different lines will now be described. A first one of the lines (404.555.1212) has one call in-progress and another call incoming (i.e., associated statuses “Call In Progress” and “Incoming Call”). A second one of the lines (404.555.1213) has one call on-hold and another call that incoming (i.e., associated statuses “On Hold” and “Incoming Call”). Accordingly, as shown, the VoIP call window 300 can simultaneously display information associated with a call that is in progress on one line, information associated with another incoming call on that line, and information associated with two other calls, one on hold and another incoming, on another line. By expanding sub-windows 310a,b and displaying the status and associated information for calls on the associated lines, a user may quickly and intuitively understand the overall status of the calls on the VoIP CPE 110 and may be able to efficiently manage those calls through the selectable buttons that are displayed therewith, such as by using the exemplary buttons described above.

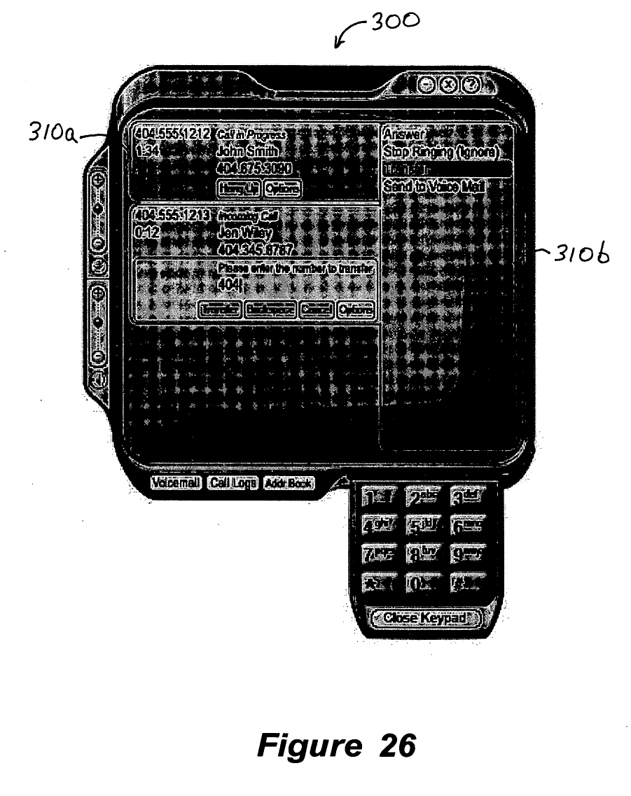

The transfer function will now be described with reference to FIG. 26. A call is shown as in-progress in sub-window 310a and an incoming call is presently being received in sub-window 310b to line 404.555.1213. The available actions that may be performed on the incoming call are displayed in a menu item list in sub-window 310b, and include “Answer”, “Stop Ringing (Ignore)”, “Transfer” and “Send to Voice Mail.” As shown, the “Transfer” menu item has been selected which caused the user to be prompted within sub-window 310b to enter the telephone number to which the incoming call is to be transferred. The transfer telephone number digits may be displayed in sub-window 310b as they are entered. The available action buttons which may be performed on the entered number are displayed in sub-window 310b, and can include “Transfer” to cause the incoming call to be transferred to the entered phone number, “Backspace” to delete the last entered digit or to delete all entered digits when the button is selected for at least a threshold time duration, and “Cancel” to cancel the transfer operation.

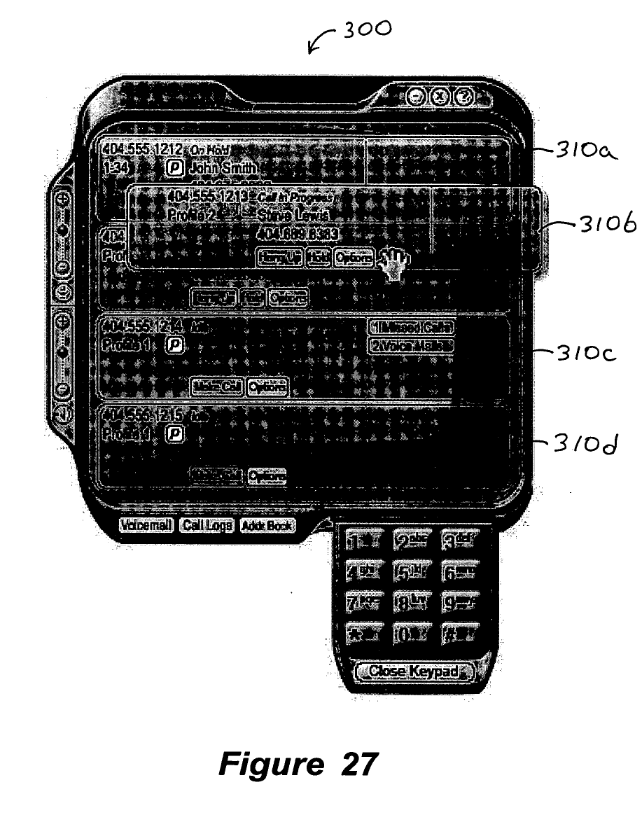

Another method and associated computer program operations for joining two calls to create a multi-party call will now be described with regard to FIG. 27. As shown in FIG. 27, a call is presently in progress in sub-window 310b on line 404.555.1213 while a call is on-hold in sub-window 310a on line 404.555.1212. A user can join the call in-progress on line 404.555.1213 with the call on-hold on line 404.555.1212 by dragging sub-window 310b so that it at least partially overlaps sub-window 310a. The call on line 404.555.1213 with phone number 404.689.8383 is moved to line 404.555.1212 to form a multi-party conference call with phone number 404.675.3090. The on-hold status for phone number 404.675.3090 is automatically changed to “Call in Progress” to reflect that all a three-way conference call has been established and the line status in sub-window 310b is return to “Idle”. The VoIP call window 300 may thereby appear as that shown in FIG. 18. Alternatively, the calls may be joined by dragging sub-window 310a so that it at least partially overlaps sub-window 310b, so that the on-hold call with phone number 404.675.3090 is joined with the in-progress call with phone number 404.689.8383 to form a three-way conference call on line 404.555.1213 with the associated status and information displayed in sub-window 310b, and line 404.555.1212 is returned to an idle state. Computer code for dragging one sub-window onto another sub-window may be provided in-part by the operation system 212, which may include routines from, for example, a Windows type operation system by Microsoft Corporation, a Macintosh type operating system by Apple Computer Corporation, or a Linux type operation system.

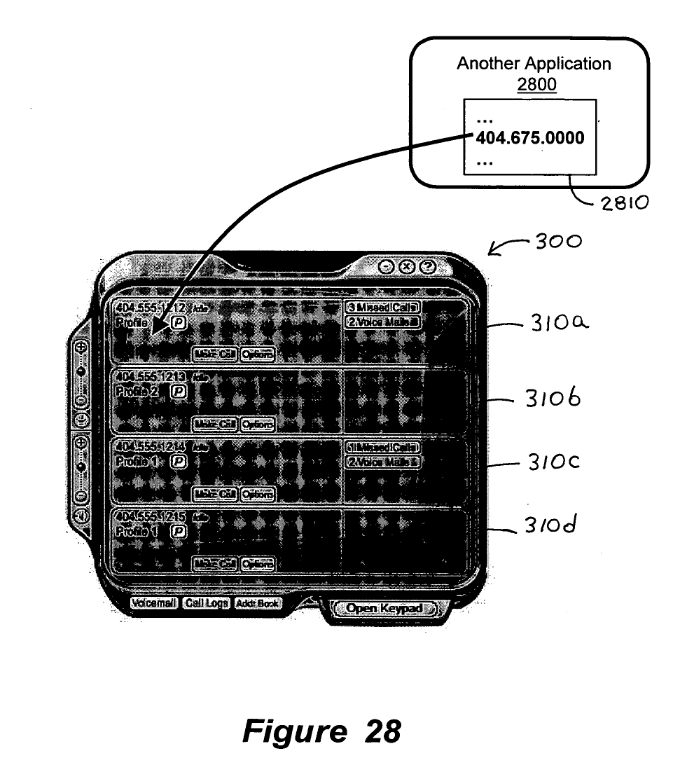

Another method and associated computer program operations for making a phone call will now be described with regard to FIG. 28. As shown in FIG. 28, another application 2800 can be hosted on the VoIP CPE 100. The application 2800 displays a phone number (404.675.0000) in a window 2810 that is separate from the VoIP call window 300. A user may drag across the display 250 the phone number (404.675.0000) from the application 2800 into sub-window 310a to initiate a call to the phone number on the line assigned to sub-window 310a. Similarly, the user may drag the phone number from application 2800 to another one of the sub-windows 310b-d to initiate a call on the corresponding phone line of VoIP CPE 110. The application 2800 may be for example, an address book application and/or messaging/mail application.

The application 2800 may be linked to the VoIP application software module 214 through a backbone message exchange application, such as an XML router, that can communicate defined types of information between the application 2800 and the VoIP application module 214 according to message formats defined by the backbone message exchange application. A user may thereby dial a phone number that resides in application 2800 by selecting that phone number to cause the phone number to be communicated via the backbone message exchange application to VoIP application module 214 and which can initiate the call responsive thereto.

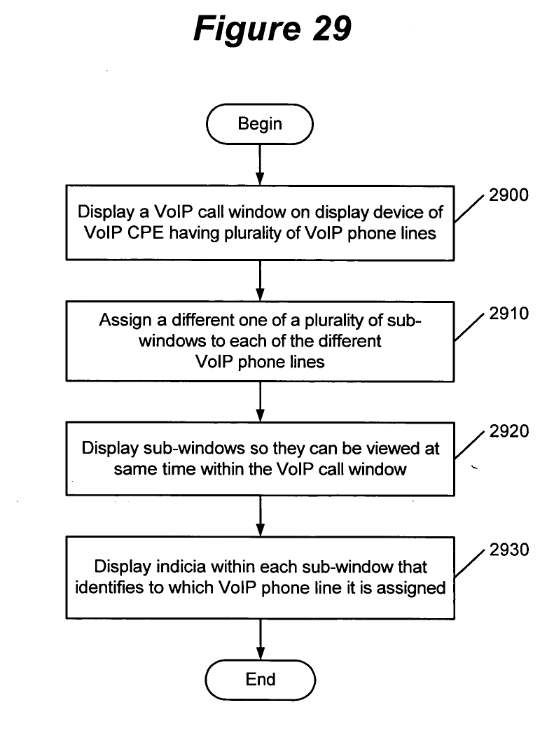

FIG. 29 is a flowchart that illustrates exemplary operations for managing a plurality of VoIP phone lines assigned to one of the VoIP CPEs of FIG. 1 according to various embodiments of the present invention. A VoIP call window is displayed (Block 2900) on a display device of a VoIP CPE. A different one of a plurality of sub-windows are assigned (Block 2910) to each of the different VoIP phone lines. The sub-windows are displayed (Block 2920) so that they can be viewed at the same time within the VoIP call window. It is to be understood that while a plurality of sub-windows are displayed for viewing, other sub-windows may not be displayed because of size and/or resolution constrains on the display 250. An indicia is displayed (Block 2930) within each sub-window that identifies to which VoIP phone line the sub-window is assigned.

In the drawings and specification, there have been disclosed embodiments of the invention and, although specific terms are employed, they are used in a generic and descriptive sense only and not for purposes of limitation, the scope of the invention being set forth in the following claims.

What is claimed:

1. A computer program product for managing a plurality of Voice-Over Internet Protocol (VoIP) phone lines assigned to a VoIP Customer Premises Equipment (CPE) and comprising a computer readable medium having computer readable program code embodied therein, the computer readable program product comprising:
computer readable program code configured to display a VoIP call window on a display device of the VoIP CPE;
computer readable program code configured to assign a different one of a plurality of sub-windows to each of the different VoIP phone lines;
computer readable program code configured to display the sub-windows so that they can be viewed at the same time within the VoIP call window; and
computer readable program code configured to display indicia within each of the sub-windows that identifies with which of the VoIP phone lines each sub-window is assigned.

2. The computer program product of claim 1, wherein when a first VoIP phone line assigned to a first one of the sub-windows is connected via a VoIP call with a first CPE, and when a second VoIP phone line assigned to a second one of the sub-windows is connected via a VoIP call with a second CPE, the computer readable program product further comprises computer readable program code configured to establish a conference call that joins the VoIP calls of the first and second CPEs on one of the first and second VoIP phone lines in response to one of the first and second sub-windows being dragged on the display device by a user so that it at least partially overlaps the other one of the first and second sub-windows.

3. The computer program product of claim 2, wherein the computer readable program code configured to establish a conference call is configured to join the VoIP calls with the first and second CPEs to establish the conference call on the first VoIP phone line and to return the second VoIP phone line to an idle state in response to the second sub-window being at least partially dragged onto the first sub-window.

4. The computer program product of claim 2, wherein the computer readable program code configured to establish a conference call is configured to join the VoIP calls with the first and second CPEs to establish the conference call on the second VoIP phone line and to return the first VoIP phone line to an idle state in response to the first sub-window being at least partially dragged onto the second sub-window.

5. The computer program product of claim 1, further comprising computer readable program code configured to display call status information for each of the VoIP phone lines in the assigned sub-windows, wherein the displayed call status information comprises indicia that identifies the assigned VoIP phone line as one of a group comprising an idle state, a call in progress state, and receiving an incoming call state.

6. The computer program product of claim 5, wherein computer readable program code configured to display call status information for each of the VoIP phone lines in the assigned sub-windows is further configured to selectively display call status information in a selected sub-window in response to a user moving a displayed cursor into the selected sub-window.

7. The computer program product of claim 5, wherein computer readable program code configured to display call status information for each of the VoIP phone lines in the assigned sub-windows is further configured to simultaneously display call status information in each of the sub-windows.

8. The computer program product of claim 1, further comprising computer readable program code configured to display indicia within each of the sub-windows that identifies a number of unanswered calls that have been directed to the VoIP phone lines assigned to those sub-windows.

9. The computer program product of claim 1, further comprising computer readable program code configured to display indicia within each of the sub-windows that identifies a number of calls recorded in a voice mailbox associated with the VoIP phone lines assigned to those sub-windows.

10. The computer program product of claim 1, wherein the computer readable program code configured to display the sub-windows is further configured to expand a displayed first one of the sub-windows in response to a user selecting a defined portion of the first sub-window, and to display in the expanded first sub-window a plurality of user selectable call dialing action indicia, and further comprising computer readable program code configured to dial a VoIP call on the VoIP phone line assigned to the first sub-window using a phone number that is selected, in response to user selection among the plurality of call dialing action indicia, among a group comprising a user entered phone number, a last called phone number, and a phone number of a previous call.

11. The computer program product of claim 1, wherein the computer readable program code configured to display the sub-windows is further configured to expand a displayed first one of the sub-windows in response to an incoming call being received on the VoIP phone line assigned to the first sub-window, and to display in the expanded first sub-window indicia that indicates that the incoming call is being received and caller ID information for the incoming call.

12. The computer program product of claim 11, further comprising computer readable program code configured to display in the expanded first sub-window a plurality of user selectable call receiving action indicia, and further comprising computer readable program code configured to carry out an action selected, in response to a user selection among the plurality of call receiving action indicia, from a group comprising answering the incoming call on the VoIP phone line assigned to the first sub-window, ignoring the incoming call, transferring the incoming call to another phone number, and sending the incoming call to a voice mailbox.

13. The computer program product of claim 11, wherein a first VoIP call is in progress on the VoIP phone line assigned to the first sub-window while the incoming call is received, and further comprising computer readable program code configured to display at the same time call status information in the first sub-window for both the first VoIP call that is in progress and the incoming call.

14. The computer program product of claim 13, further comprising computer readable program code configured to display in the first sub-window a plurality of user selectable call receiving action indicia, and further comprising computer readable program code configured to carry out an action selected, in response to a user selection among the plurality of call receiving action indicia, from a group comprising answering the incoming VoIP call while substantially simultaneously placing the first VoIP call on hold, joining the first VoIP call and the incoming call into a multi-party conference call, transferring the incoming call to another phone number, and sending the incoming VoIP call to a voice mailbox.

15. The computer program product of claim 14, wherein the computer readable program code configured to carry out an action is further configured to select the action from the group which further comprises adding a phone number of the incoming call to a blocking list of phone number and to subsequently block incoming phone calls that originate from phone numbers corresponding to those contained in the blocking list.

16. The computer program product of claim 1, wherein the computer readable program code configured to display the sub-windows is further configured to expand a displayed first one of the sub-windows in response to a user selecting a defined portion of the first sub-window when a VoIP call is in progress on the VoIP phone line assigned to the first sub-window, and to display in the expanded first sub-window a plurality of user selectable call in progress action indicia, and further comprising computer readable program code configured to carry out an action selected, in response to a user selection among the plurality of call in progress action indicia, from a group comprising transferring the VoIP call to another phone number, sending the VoIP call to a voice mailbox, placing the VoIP call on hold, terminating the VoIP call, and joining the VoIP call with another VoIP call to form a multi-party conference call.

17. The computer program product of claim 1, further comprising computer readable program code configured to associate a plurality of user defined line profiles into a profile list, to selectively assign one of the line profiles from the profile list to one of the sub-windows in response to a user command, and to display in the sub-windows an indicia that identifies which one of the line profiles is assigned to the respective sub-windows.

18. The computer program product of claim 17, wherein each of the line profiles in the list can define a group of blocked phone numbers, and further comprising computer readable program code configured to block an incoming phone call to a VoIP phone line assigned to a first one of the sub-windows when a phone number of the incoming call is in the group of blocked phone numbers defined by a line profile assigned to the first sub-window.

19. The computer program product of claim 17, wherein each of the line profiles in the list can define a phone number to which an incoming call is to be forwarded, and further comprising computer readable program code configured to forward an incoming phone call which is directed to a VoIP phone line assigned to a first one of the sub-windows instead to a phone number defined by a line profile assigned to the first sub-window.

20. The computer program product of claim 17, wherein each of the line profiles in the list can define a do-not-disturb status that is selectively enabled and disabled, and further comprising computer readable program code configured to selectively generate an audible incoming call announcement to a user based on a do-not-disturb status defined by a line profile assigned to the first sub-window.

21. The computer program product of claim 20, wherein the computer readable program code configured to selectively generate an audible incoming call announcement to a user based on a do-not-disturb status defined by a line profile assigned to the first sub-window is further configured to send an incoming call to a voice mailbox associated with the VoIP phone line assigned to the first one of the sub-windows when the defined do-not-disturb status is enabled.

22. The computer program product of claim 1, further comprising computer readable program code configured to make a VoIP phone call on a VoIP phone line assigned to first one of the sub-windows in response to a user dragging a phone number on the display device from a software application on the VoIP CPE to the first sub-window.

23. The computer program product of claim 1, further comprising:
computer readable program code configured to receive a phone number from a software application on the VoIP CPE in response to a user selecting the phone number in the software application; and
computer readable program code configured to make a VoIP phone call to the received phone number using a VoIP phone line assigned to first one of the sub-windows.

24. A method of managing a plurality of Voice-Over Internet Protocol (VoIP) phone lines assigned to a VoIP Customer Premises Equipment (CPE), the method comprising:
displaying a VoIP call window on a display device of the VoIP CPE;
assigning a different one of a plurality of sub-windows to each of the different VoIP phone lines;
displaying the sub-windows so that they can be viewed at the same time within the VoIP call window;
displaying an indicia within each of the sub-windows that identifies with which of the VoIP phone lines each sub-window is assigned.

25. The method of claim 24, when a first VoIP phone line assigned to a first one of the sub-windows is connected via a VoIP call with a first CPE, and when a second VoIP phone line assigned to a second one of the sub-windows is connected via a VoIP call with a second CPE, the method further comprises establishing a conference call that joins the VoIP calls of the first and second CPEs on one of the first and second VoIP phone lines in response to one of the first and second sub-windows being dragged on the display device by a user so that it at least partially overlaps the other one of the first and second sub-windows

26. The method of claim 24, further comprising displaying call status information for each of the VoIP phone lines in the assigned sub-windows, wherein the displayed call status information comprises indicia that identifies the assigned VoIP phone line as one of a group comprising an idle state, a call in progress state, and receiving an incoming call state.

27. The method of claim 24, further comprising:
forming a profile list that contains a plurality of user defined line profiles;
selectively assigning one of the line profiles from the profile list to one of the sub-windows in response to a user command; and
displaying in the sub-windows an indicia that identifies which one of the line profiles is assigned to the respective sub-windows.
